(19) United States
(12) Patent Application Publication
(10) Pub. No.: US 2006/0244685 A1
(43) Pub. Date: Nov. 2, 2006

(54) Plasma display apparatus and image processing method thereof

(75) Inventors: Won Jae Kim, Masan-si (KR); Ki Duck Cho, Changwon-si (KR); Sung Im Lee, Gumi-si (KR); Minsoo Kim, Gumi-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/351,119

(22) Filed: Feb. 10, 2006

(30) Foreign Application Priority Data
Apr. 27, 2005 (KR) 10-2005-0035263
Aug. 6, 2005 (KR) 10-2005-0072038

(51) Int. Cl. G09G 3/28

(52) U.S. Cl. 345/67

(57) ABSTRACT

A plasma display apparatus is disclosed to prevent an erroneous discharge when a plasma display panel is driven and drive the plasma display panel at a high speed. The plasma display apparatus comprises a plasma display panel (PDP) comprising a scan electrode, a sustain electrode and an address electrode, a scan driver for applying a set-up waveform which rises up to a first voltage at a first slope and then rises up to a second voltage at a second slope to the scan electrode during a reset period, and an address driver for applying a first positive polarity pulse to the address electrode while the set-up waveform is being applied to the scan electrode.

This Nonprovisional application claims priority under 35 U.S.C. § 119(a) on Patent Application No. 10-2005-0035263 filed in Republic of Korea on Apr. 27, 2005, Korean Patent Application No. 10-2005-0072038 filed in Republic of Korea on Aug. 6, 2005 the entire contents of which are hereby incorporated by reference.

### BACKGROUND OF THE INVENTION

1. Field of the Invention

The present invention relates to display apparatus and, more particularly, to a plasma display apparatus.

2. Description of the Related Art

Generally, a plasma display apparatus is a display apparatus comprising a plasma display panel (PDP) for displaying an image and drivers for driving the PDP.

In the PDP, when an inert mixture gas such as helium-xenon (He—Xe), helium-neon (He—Ne), or the like, is discharged, vacuum ultraviolet rays are generated to illuminate phosphor to thereby allow displaying of images.

The plasma display apparatus can have a thin film and be easily enlarged in size, and due to the recent technical developments, its image quality has been improved.

FIG. 1 shows the structure of a related art PDP.

As shown in FIG. 1, the PDP is constructed by coupling a front panel 100 comprising a front substrate 101, namely, a display surface on which an image is displayed, on which a plurality of sustain electrodes comprising a pair of scan electrode 102 and a sustain electrode 103 are arranged, and a rear panel 110 comprising a rear substrate 111, forming a rear surface, on which a plurality of address electrodes 113 are arranged to cross the plurality of sustain electrodes, in parallel with a certain distance therebetween.

The front panel 100 comprises the scan electrode 102 and the sustain electrode 103 for mutually performing a discharge in a single cell and sustaining illumination of the cell, namely, the pair of the scan electrode 102 and the sustain electrode 103 each comprising a transparent electrode (a) made of a transparent ITO material and a bus electrode (b) made of a metal material. The scan electrode 102 and the sustain electrode are covered by at least one (or more) upper dielectric layer 104 which limits a discharge current and insulates the pair of electrodes, and a protection layer 105 is formed by depositing a magnesium oxide (MgO) on the upper surface of the upper dielectric layer 104.

On the rear panel 110, a plurality of barrier ribs 112 of a stripe type (or a well type) are arranged in parallel to form a plurality of discharge spaces, namely, discharge cells. In addition, a plurality of address electrodes 113 for generating vacuum ultraviolet rays by performing an address discharge are disposed in parallel with respect to the barrier ribs 112. R, G and B phosphor 114 for emitting visible light to display an image during the address discharge is coated on the upper surface of the rear panel 110. A lower dielectric layer 115 for protecting the address electrodes 113 is formed between the address electrode 113 and the phosphor 114.

FIG. 2 shows a method for implementing gray levels of the related art plasma display apparatus.

As shown in FIG. 2, as for a method for representing gray levels of an image of the related art plasma display apparatus, one frame is divided into several sub-fields each having a different number of times of illumination, and each sub-field is divided into a reset period (RPD) for initializing every cell again, an address period (APD) for selecting a cell to be discharged, and a sustain period (SPD) for implementing gray levels according to the number of times of discharge. For example, when an image is displayed by 256 gray levels, a frame period (16.67 ms) corresponding to 1/60 seconds is divided into eight sub-fields (SF1-SF8) as shown in FIG. 2 and each of the eight sub-fields (SF1-SF8) is divided into the reset period (RPD), the address (APD) and the sustain (SPD).

The reset period and the address period are the same in each sub-field. The address discharge for selecting a cell to be discharged occurs by a voltage difference between the address electrode and the transparent electrode of the scan electrode. The sustain period increases at the rate of 2ⁿ (n=0, 1, 2, 3, 4, 5, 6 and 7) in each sub-field. Thus, the sustain period differs in each sub-field, based on which gray levels of an image are represented by controlling the sustain period of each sub-field, namely, by controlling the number of times of a sustain discharge.

FIG. 3 is a driving waveform view according to the method for driving the related art plasma display apparatus.

As shown in FIG. 3, the plasma display apparatus is driven (operated) according to the reset period for initializing every cell, the address period for selecting a cell to be discharged and the sustain period for sustaining a discharge of a selected cell, as divided.

During a set-up period of the reset period, a ramp-up waveform is applied to every scan electrode, simultaneously, according to which a weak dark discharge occurs in each discharge cell of the entire screen. Positive polarity wall charges are accumulated in the address electrode and the sustain electrode and negative polarity wall charges are accumulated in the scan electrode according to the set-up discharge.

During a set-down period of the reset period, the supplied ramp-up waveform is turned to be a ramp-down waveform as it falls starting from a positive polarity voltage lower than a peak voltage of the ramp-up waveform down to a specific voltage level below a ground (GND) level, causing a weak erase discharge in each cell to sufficiently erase wall charges excessively formed in the scan electrode. Due to the set-down discharge, wall charges that allow stable address discharging to occur can remain uniformly in each cell.

During the address period, a scan reference waveform of a scan reference voltage (Vsc) is applied to the scan electrode (Y), and a negative polarity scan voltage (−Vy) falling from the scan reference voltage (Vsc) of the scan reference waveform is sequentially applied to the scan electrodes (Y), and at the same time, a positive polarity data voltage corresponding to the scan voltage is applied to the address electrodes. As the difference between the scan voltage and the data voltage and a wall voltage generated during the reset period are added, the address discharge occurs in the discharge cell to which the data voltage is being applied. Wall charges, that are sufficient to allow discharge to occur when a sustain pulse (SUS) of the sustain voltage (Vs) is applied, are formed in cells selected by the address discharge. A sustain bias voltage (Vz) is supplied to the sustain electrode (Z) during the set-down period and the address period so as not to cause an erroneous discharge with respect to the scan electrode (Y) by reducing a voltage difference between the sustain electrode (Z) and the scan electrode (Y).

During the sustain period, a sustain pulse (Sus) of the sustain voltage (Vs) is alternately applied to the scan electrodes and the sustain electrode. In a cell selected by the address discharge, a sustain discharge, namely, a display discharge, occurs between the scan electrode (Y) and the sustain electrode (Z) whenever each sustain pulse (Sus) is applied as the wall voltage within the cell and the sustain voltage (Vs) of the sustain pulse (Sus) are added.

After the sustain discharge is completed, during an erasing period, a voltage of an erase ramp (Ramp-ers) waveform with a relatively small pulse width and voltage level is supplied to the sustain electrode (Z) to erase wall charges remaining within the cells of the entire screen.

Recently, the distance between the scan electrode (Y) and the sustain electrode (Z) is increased to enhance brightness in driving the plasma display apparatus.

The increase in the distance between the scan electrode (Y) and the sustain electrode can lead to enlargement of a positive column to enhance the luminance efficiency, but on the other hand, it inevitably causes an increase in a driving voltage. Accordingly, there can be a high probability that spots are generated during the reset period to cause an erroneous discharge, and in addition, the amount of power consumption is increased to degrade the driving efficiency.

Such problems will now be described in detail by using a discharge occurrence principle in the PDP and a hexagonal voltage curve (Vt-Curve) used for measurement of a voltage margin as shown in FIG. 4.

FIG. 4 illustrates a distribution of a discharge firing voltage according to a distance between electrodes.

As shown in FIG. 4, a horizontal axis indicates a relative voltage difference between the sustain electrode (Z) and the scan electrode (Y), and a vertical axis indicates a relative voltage difference between the address electrode (X) and the scan electrode (Y).

The interior region of the hexagonal voltage curve shown in FIG. 4 is where the wall charges are distributed inside the discharge cell, and no discharge occurs in the region.

A voltage Vf1 indicated in surface discharge region of a third quadrant of the voltage curve indicates a discharge firing voltage (at which a discharge is initiated) between the scan electrode (Y) and the sustain electrode (Z) in case where the distance between the scan electrode (Y) and the sustain electrode (Z) is relatively short. A voltage Vf2 indicates a discharge firing voltage between the scan electrode (Y) and the sustain voltage (Z) in case where the distance between the scan electrode (Y) and the sustain electrode (Z) is relatively long.

As noted in FIG. 4, the discharge firing voltage increases in proportion to the difference of the distances between the scan electrode (Y) and the sustain electrode (Z), which can be expressed by equation (1) shown below:
ΔV=Vf2=Vf1 Equation 1

As noted through equation (1) and FIG. 4, the difference (ΔV) of the discharge firing voltage is made according to the distance between the scan electrode (Y) and the sustain electrode (Z)

The discharge occurring by a set-up voltage of the set-up waveform applied during the set-up period of the reset period of the driving waveform shown in FIG. 3 in accordance with the related art will now be described by using the hexagonal voltage curve with reference to FIG. 5.

FIG. 5 shows a process of a change in a cell voltage when the set-up voltage of the set-up waveform in accordance with the related art is applied to the scan electrode (Y) according to a distance between discharge electrodes.

With reference to FIG. 5, a point ‘A’ indicates a wall voltage right after the sustain voltage (Vs) of the last sustain pulse is applied to the sustain electrode (Z).

Herein, when the ramp-up waveform according to the related art driving method is supplied to the scan electrode (Y) during the set-up period of the reset period, a discharge cell voltage moves by way of the surface discharge region of the third quadrant in the direction of an arrow as shown from the point ‘A’. Here, when the discharge cell voltage reaches a boundary value of the surface discharge region of the third quadrant, a surface discharge occurs between the scan electrode (Y) and the sustain electrode (Z).

In this case, if the distance between the scan electrode (Y) and the sustain electrode (Z) is relatively short, the surface discharge occurs at a point ‘A′’.

Meanwhile, if the distance between the scan electrode (Y) and the sustain electrode (Z) is relatively long, the surface discharge occurs at a point ‘A″’.

Herein, as shown, the point ‘A″’ is a region where there is a high probability that the surface discharge and a facing discharge coexist.

To sum up the above descriptions with reference to FIGS. 4 and 5, when the distance between the scan electrode (Y) and the sustain electrode (Z) is intentionally increased to enhance the luminance efficiency, the probability that the unintentional facing discharge occurs between the scan electrode (Y) and the address electrode (X) during the set-up period of the reset period is relatively increased. The occurrence of the unintentional facing discharge between the scan electrode (Y) and the address electrode (X) during the set-up period of the re-set period inevitably degrades the brightness of the PDP and causes an erroneous discharge to make an overall driving unstable.

### SUMMARY OF THE INVENTION

Accordingly, one object of the present invention is to solve at least the problems and disadvantages of the background art.

Another object of the present invention is to provide a plasma display apparatus capable of improving driving pulses applied to a scan electrode and an address electrode.

To achieve the above objects, there is provided a plasma display apparatus in accordance with a first embodiment of the present invention, comprising a plasma display panel (PDP), a scan driver, and an address driver. The PDP comprises a scan electrode, a sustain electrode and an address electrode. The scan driver applies a set-up waveform, which rises up to a first voltage at a first slope and then rises up to a second voltage at a second slope, to the scan electrode during a reset period. The address driver applies a first positive polarity pulse to the address electrode while the set-set waveform is being applied to the scan electrode.

To achieve the above objects, there is also provided a plasma display apparatus in accordance with a second embodiment of the present invention, comprising a plasma display panel (PDP), a scan driver, a sustain driver and an address driver. The PDP comprises a scan electrode, a sustain electrode and an address electrode. The scan driver applies a set-up waveform, which rises up to a first voltage at a first slope and then rises up to a second voltage at a second slope, to the scan electrode during a reset period. The sustain driver applies a sustain bias waveform, which has a rising slope, to the sustain electrode during a rear portion of the reset period and an address period following (after) the reset period. The address driver applies a first positive polarity pulse to the address electrode while the set-up waveform is being applied to the scan electrode.

To achieve the above objects, there is also provided a plasma display apparatus in accordance with a third embodiment of the present invention, comprising a plasma display panel (PDP), a scan driver, a sustain driver and an address driver. The PDP comprises a scan electrode, a sustain electrode and an address electrode. The scan driver applies to the scan electrode a first ramp-up waveform, which rises to a first voltage at a first slope and then rises to a second voltage at a second slope, during a set-up period, a ramp-down waveform, which falls to a third voltage, during a set-down period, a second ramp-up waveform, which rises from the third voltage to a fourth voltage, during an address period, and then a scan pulse which falls to a fifth voltage from the fourth voltage. The address driver applies a first positive polarity pulse to the address electrode while the set-up waveform is being applied to the scan electrode.

In the present invention, when the PDP is driven (operated), an occurrence of an erroneous discharge can be prevented and the PDP can be driven at a high speed.

### BRIEF DESCRIPTION OF THE DRAWINGS

The invention will be described in detail with reference to the following drawings in which like numerals refer to like elements.

FIG. 1 shows the structure of a plasma display panel (PDP) in accordance with a related art.

FIG. 2 shows a method for implementing gray levels of a plasma display apparatus in accordance with the related art.

FIG. 3 is a view showing driving waveforms according to a method for driving the plasma display apparatus in accordance with the related art.

FIG. 4 illustrates a distribution of a discharge firing voltage according to a distance between electrodes.

FIG. 5 shows a process of a change in a cell voltage when a set-up voltage of a set-up waveform in accordance with the related art is applied to a scan electrode (Y) according to a distance between discharge electrodes.

FIG. 6 shows the structure of a plasma display apparatus in accordance with a first embodiment of the present invention.

FIG. 7 is a view for explaining a method for driving the plasma display apparatus in accordance with the first embodiment of the present invention.

FIG. 8 is a view for explaining discharge characteristics obtained according to whether or not a first positive polarity pulse is applied to an address electrode of the plasma display apparatus in accordance with the first embodiment of the present invention.

FIG. 9 is a view for explaining a second positive polarity pulse applied to the address electrode during a sustain period when the plasma display apparatus is driven in accordance with the first embodiment of the present invention.

FIG. 10 is a view showing a voltage curve (Vt-Curve) for explaining a process of a change in a voltage within a discharge cell during a set-up period when the plasma display apparatus is driven in accordance with the first embodiment of the present invention.

FIGS. 11a and 11b are views showing driving waveforms at a plurality of sub-field sections when the plasma display apparatus is driven in accordance with the first embodiment of the present invention.

FIG. 12 is a view showing sizes of voltages of set-up waveforms applied to a scan electrode in the plurality of sub-fields when the plasma display apparatus is driven in accordance with the first embodiment of the present invention.

FIGS. 13a and 13b are views for explaining a method for driving a plasma display apparatus in accordance with a second embodiment of the present invention.

FIG. 14 is a view showing a waveform applied to a sustain electrode (Z) during a rear portion of a reset period when the plasma display apparatus is driven in accordance with the second embodiment of the present invention.

FIGS. 15a and 15b are views for explaining a method for driving a plasma display apparatus in accordance with a third embodiment of the present invention.

FIG. 16 is a view showing a waveform applied to a scan electrode (Y) during the rear portion of the reset period when a plasma display apparatus is driven in accordance with the third embodiment of the present invention.

FIGS. 17 and 18 are views for explaining noise according to a scan reference waveform with respect to driving waveforms of a related art and those of the present invention.

FIG. 19 is a view for explaining scan electrode groups of a plasma display panel (PDP) in accordance with the present invention.

FIGS. 20a and 20b are views for explaining a driving method for controlling time for applying a second ramp-up waveform according to the scan electrode group in accordance with the present invention.

FIGS. 21a and 21b are views for explaining a driving method for differently controlling time for applying the second ramp-up waveform according to the scan electrode groups in accordance with the present invention.

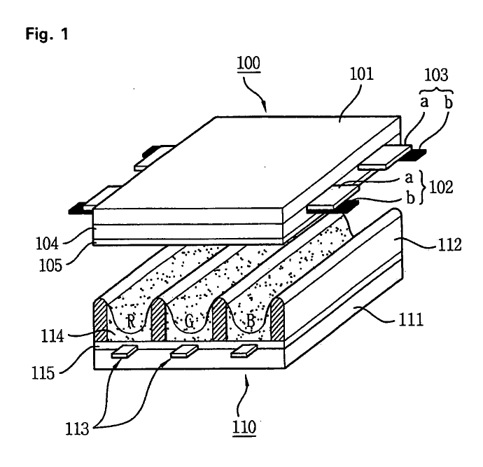

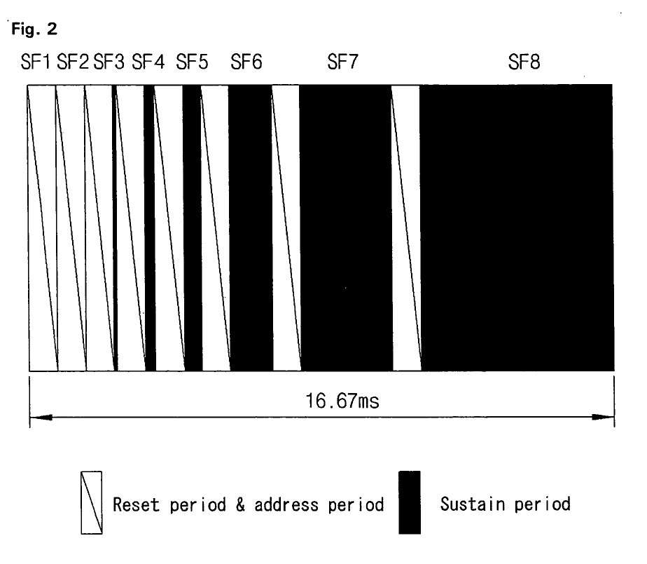

### DETAILED DESCRIPTION OF THE PREFERRED EMBODIMENT

Preferred embodiments of the present invention will be described in a more detailed manner with reference to the drawings.

The plasma display apparatus in accordance with the first embodiment of the present invention comprises a plasma display panel (PDP) comprising a scan electrode, a sustain electrode and an address electrode, a scan driver for applying a set-up waveform which rises up to a first voltage at a first slope and then rises up to a second voltage at a second slope to the scan electrode during a reset period, and an address driver for applying a first positive polarity pulse to the address electrode while the set-up waveform is being applied to the scan electrode.

A peak voltage of the first positive polarity pulse is between 1 to 1.5 times the voltage of a data pulse applied to the address electrode during an address period.

The first positive polarity pulse is applied in synchronization with the set-up waveform.

The first positive polarity pulse is applied to the address electrode at one or more of the plurality of sub-fields.

The first positive polarity pulse has the largest pulse width at a sub-field with the lowest gray level weight value among the plurality of sub-fields.

The first positive polarity pulse is applied at at least one of first to third sub-fields in the sequential order beginning from the sub-field with the lowest gray level weight value.

The first slope is greater than the second slope.

The size of the first voltage is the same as that of a voltage of a scan reference waveform applied to the scan electrode during the address period following (after) the reset period.

The size of the second voltage applied to the scan electrode at one of the plurality of sub-fields is different from that of the second voltage applied to the scan electrode at the other remaining sub-fields.

A sustain bias waveform having a voltage size between 80V and 120V is applied to the sustain electrode during the address period.

First sustain pulses respectively applied to the scan electrode and the sustain electrode do not overlap with each other, and last sustain pulses respectively applied to the scan electrode and the sustain electrode do not overlap with each other.

While the first sustain pulse is being applied to the scan electrode or to the sustain electrode, a second positive polarity pulse is applied to the address electrode.

A voltage of the second positive polarity pulse is the same as that of the first positive polarity pulse or that of the data pulse applied to the address electrode.

The distance between the scan electrode and the sustain electrode is not smaller than 90 μm but not greater than 200 μm.

A plasma display apparatus in accordance with a second embodiment of the present invention comprises a PDP comprising a scan electrode, a sustain electrode and an address electrode, a scan driver for applying a set-up waveform which rises up to a first voltage at a first slope and then rises up to a second voltage at a second voltage to the scan electrode during a reset period, a sustain driver for applying a sustain bias waveform with a rising slope to the sustain electrode during a rear portion of the reset period and an address period following the reset period, and an address driver for applying a first positive polarity pulse to the address electrode while the set-up waveform is being applied to the scan electrode.

The rising slope starts from a voltage higher than a ground level.

A plasma display apparatus in accordance with a third embodiment of the present invention comprises a PDP comprising a scan electrode, a sustain electrode and an address electrode, a scan driver for applying to the scan electrode a first ramp-up waveform which rises up to a first voltage at a first slope and then rises up to a second voltage at a second slope during a set-up period, a ramp-down waveform which falls down to a third voltage during a set-down period, applying a second ramp-up waveform which rises up to a fourth voltage from the third voltage during an address period, and then applying a scan pulse which falls down to a fifth voltage from the fourth voltage, and an address driver for applying a first positive polarity pulse to the address electrode while the set-up waveform is being applied to the scan electrode.

A slope of the second ramp-up waveform is smaller than that of a sustain pulse applied during a sustain period.

The second ramp-up waveform is sustained at the fourth voltage during a certain period.

The ramp-up waveform is applied until before a first one of scan pulses applied to the scan electrode is applied.

The plasma display apparatus in accordance with the present invention will now be described in detail with reference to the accompanying drawings.

### First Embodiment

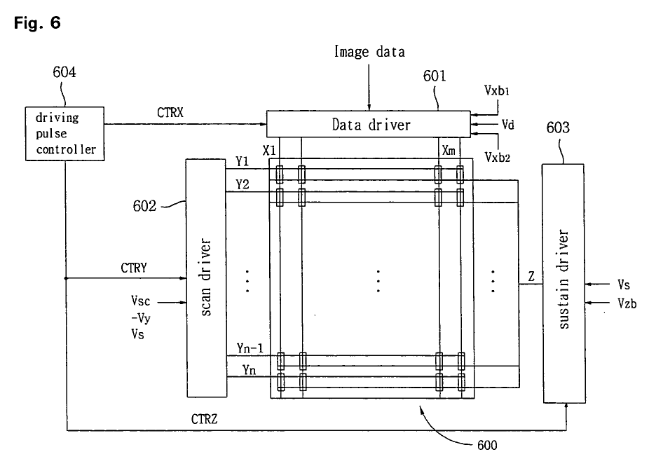

FIG. 6 shows the structure of a plasma display apparatus in accordance with a first embodiment of the present invention.

As shown in FIG. 6, the plasma display apparatus in accordance with the first embodiment of the present invention comprises a PDP 600, an address driver 601, a scan driver 602, a sustain driver 603 and a driving pulse controller 604.

In the PDP 600 formed by attaching a front panel (not shown) and a rear panel (not shown) with a certain space therebetween, a plurality of electrodes, for example, scan electrodes (Y1 to Yn) and sustain electrodes, are formed as pairs, and address electrodes (X1 to Xm) are formed to cross the scan electrodes (Y1 to Yn) and the sustain electrodes (Z).

Data, which has been reverse gamma corrected and half tone corrected by a reverse gamma correction circuit (not shown) and an error diffusion circuit (not shown) and then mapped to each sub-field by a sub-field mapping circuit, is supplied to the address driver 601. The address driver 601 applies a certain driving voltage to the address electrodes (X1 to Xm) during one or more of a reset period, an address period and a sustain period. Specifically, the address driver 601 applies a first positive polarity pulse to the address electrode while the set-up waveform is being applied to the scan electrode during the reset period, and applies data supplied during the address period to the address electrodes (X1 to Xm) under the control of the driving pulse controller 604.

The scan driver 602 applies a certain driving voltage to the scan electrodes (Y1 to Yn) during one or more of the reset period, the address period and the sustain period under the control of the driving pulse controller 604. Specifically, the scan driver 602 applies to the scan electrodes (Y1 to Yn) a set-up waveform with two slopes during a set-up period of the reset period and a set-down waveform during a set-down period of the reset period. The set-up waveform refers to a waveform whose voltage value increases gradually and the set-down waveform refers to a waveform whose voltage value decreases gradually. In addition, the scan driver 602 sequentially applies a scan pulse of a negative polarity scan voltage to the scan electrodes (Y1 to Yn) during the address period and applies a sustain pulse to the scan electrodes (Y1 to Yn) during the sustain period.

The sustain driver 603 applies a certain driving voltage to the sustain electrodes (Z) during one or more of the reset period, the address period and the sustain period under the control of the driving pulse controller 604. Specifically, the sustain driver 603 supplies a sustain bias waveform to the sustain electrodes (Z) during the address period and supplies the sustain pulse to the sustain electrodes (Z) during the sustain period by alternately operating with the scan driver 602.

The driving pulse controller 604 generates certain control signals (CTRX, CTRY and CTRZ) for controlling an operation timing and synchronization of the address driver 601, the scan driver 602 and the sustain driver 603 during the reset period, the address period and the sustain period, and supplies the control signals to the address driver 601, the scan driver 602 and the sustain driver 603, respectively, to control them.

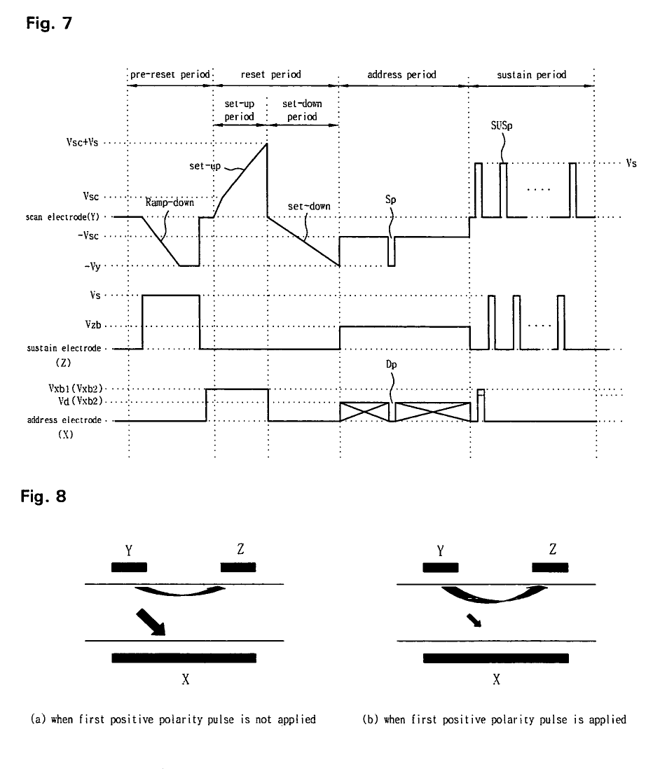

FIG. 7 is a view for explaining a method for driving the plasma display apparatus in accordance with the first embodiment of the present invention.

As illustrated, according to the method for driving the plasma display apparatus in accordance with the first embodiment of the present invention, the set-up waveform which gradually rises up to a first voltage (Vsc) at a first slope and then rises up to a second voltage (Vsc+Vs) at a second slope is applied to the scan electrode during the set-up period of the reset period, and a first positive polarity pulse is applied to the address electrode (X) while the set-up waveform is being applied to the scan electrode (Y). In this case, the first positive polarity pulse can be a ramp waveform with a slope or can be a square wave. In addition, a time point at which the first positive polarity pulse is applied can be different from or the same as a time point at which the set-up waveform is applied.

An absolute value of the first slope of the set-up waveform can be smaller than that of the second slope, and preferably, it is greater than the second slope. The reason for this is because a discharge does not easily occur at the initial stage when the set-up waveform is applied, the more the first slope is increased, the more advantageous a timing margin of the reset period can be obtained.

The first voltage of the set-up waveform has the substantially same size as the scan reference voltage (Vsc) of a scan reference waveform applied to the scan electrode (Y) during the address period following the reset period, and preferably, the size is between 100V and 150V. For example, in case where a voltage of the scan reference waveform applied to the scan electrode (Y) during the address period is −Vsc, the size of the first voltage is Vsc of |−Vsc|.

The size of the second voltage of the set-up waveform is substantially the sum of the voltage (Vsc) of the scan reference waveform and the sustain voltage (Vs) applied during the sustain period, which is, preferably, between 230V and 350V.

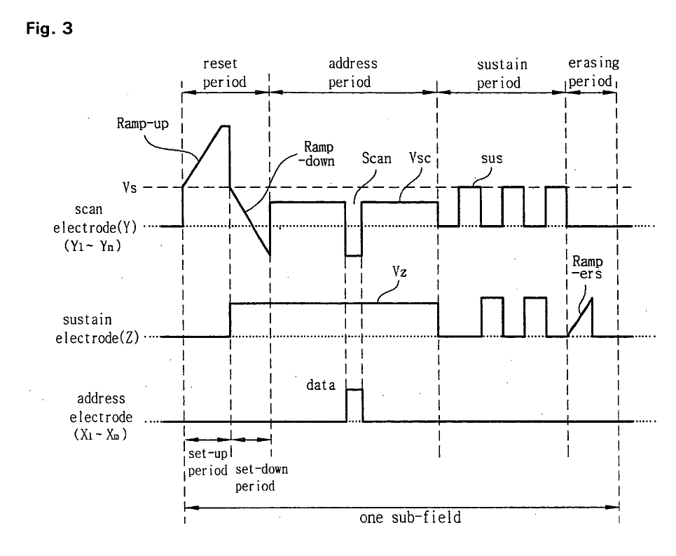

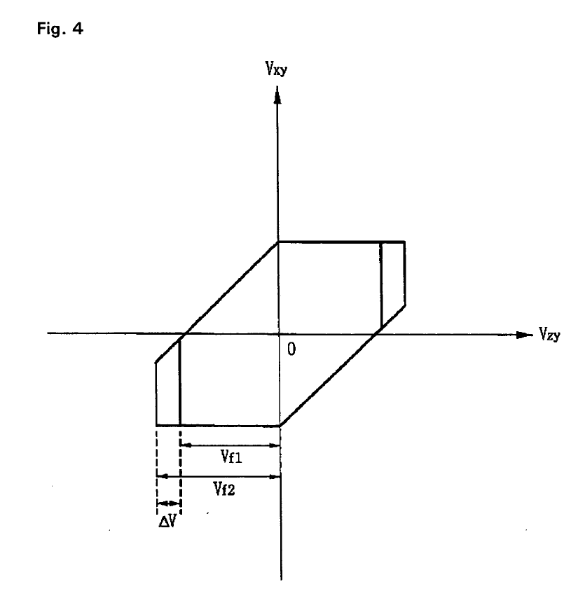

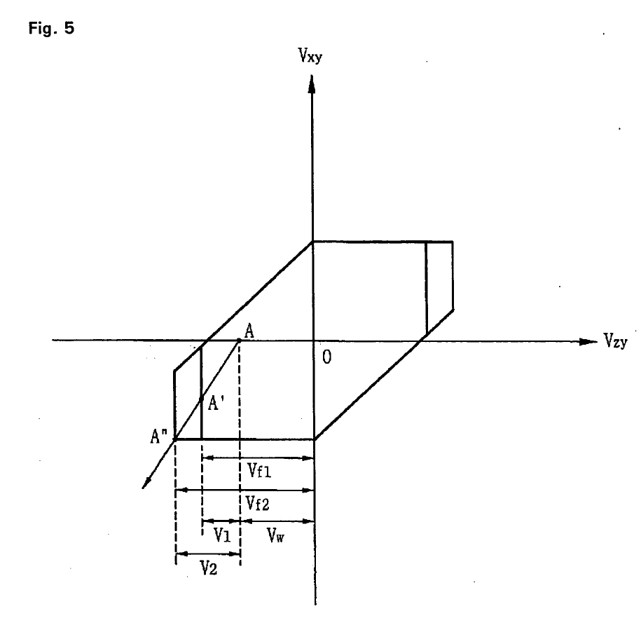

Compared with the set-up waveform applied during the reset period when the related art plasma display apparatus as shown in FIG. 3 is driven, each size of the first and second voltage of the set-up waveform is relatively small. This is because a pre-reset period during which wall charges can be sufficiently accumulated is additionally provided before the reset period.

The pre-reset period can be included in each of the plurality of sub-fields, and preferably, it comes before the reset period of the first sub-field in order to obtain a timing margin. For example, on the assumption that one frame comprises total 12 sub-fields from a first one to the twelfth one in the sequential order of the size of a gray level weight value, the pre-reset period is included before the reset period of the first sub-field, namely, the sub-field having the lowest gray level weight value, among the twelve sub-fields.

A negative polarity waveform including a ramp-down waveform whose voltage is gradually decreased is applied to the scan electrode (Y) during the pre-reset period, and a positive polarity waveform is applied to the sustain electrode (Z). In this case, the negative polarity waveform has the substantially same voltage as a voltage (−Vy) of the scan pulse (SP) applied to the scan electrode (Y) during the address period. That is, the negative polarity waveform can be generated during the pre-reset period and the scan pulse can be generated during the address period by using the same voltage source.

The positive polarity waveform has the substantially same voltage as the voltage (Vs) of the sustain pulse applied during the sustain voltage. Likewise, a positive polarity waveform can be generated during the pre-reset period and a sustain pulse can be generated during the sustain period by using the same voltage source.

During the pre-reset period, positive polarity wall charges are accumulated in the scan electrode (Y) according to the negative polarity waveform applied to the scan electrode (Y) while negative polarity wall charges are accumulated in the sustain electrode (Z) within discharge cells according to the negative polarity waveform applied to the sustain electrode (Z).

The wall charges formed in the discharge cells during the pre-reset period are sustained even during the reset period of the first sub-field with the lowest gray level weight value, and accordingly, although the voltage of the set-up waveform applied during the reset period of the first sub-field is set to be the sum of the scan reference voltage (Vsc) and the sustain voltage (Vs), resetting can be performed.

The reason for applying the first positive polarity pulse to the address electrode (X) is to prevent occurrence of an unstable discharge during the reset period, and in this case, it is preferred that a peak voltage (Vxb1) of the first positive polarity pulse is between 1 to 1.5 times the data voltage (Vd) applied to the address electrode (X) during the address period. This will now be described in detail with reference to FIG. 8.

FIG. 8 is a view for explaining discharge characteristics obtained according to whether or not the first positive polarity pulse is applied to the address electrode of the plasma display apparatus in accordance with the first embodiment of the present invention.

FIG. 8(a) shows strength of a set-up discharge within the discharge cells when the first positive polarity pulse is not applied to the address electrode (X) in a long gap structure in which a distance between the scan electrode (Y) and the sustain electrode (Z) is longer than that between the scan electrode (Y) and the address electrode (X), and FIG. 8(b) shows strength of a set-up discharge within the discharge cells when the first positive polarity pulse is applied to the address electrode (X) in the same structure.

First, with reference to FIG. 8(a), because the distance between the scan electrode (Y) and the sustain electrode (Z) is relatively long and the distance between the scan electrode (Y) and the address electrode (X) is relatively short, when the set-up waveform is applied to the scan electrode (Y) during the set-up period of the reset period, a facing discharge occurring between the scan electrode (Y) and the address electrode (X) is stronger than a surface discharge occurring between the scan electrode (Y) and the sustain electrode (Z). Then, problems arise that the reset discharge becomes unstable and spots are generated.

Meanwhile, with reference to FIG. 8(b), when the first positive polarity pulse is applied to the address electrode (X) while the set-up waveform is being applied to the scan electrode (Y), although the distance between the scan electrode (Y) and the sustain electrode (Z) is relatively long and the distance between the scan electrode (Y) and the address electrode (X) is relatively short, a voltage difference between the scan electrode (Y) and the address electrode (X) when the set-up waveform is applied to the scan electrode (Y) during the set-up period of the reset period can be reduced and thus the surface discharge between the scan electrode (Y) and the sustain electrode (Z) can be strengthened and the facing discharge between the scan electrode (Y) and the address electrode (X) can be relatively weakened, thereby stabilizing the reset discharge and restraining generation of spots.

During the set-down period after the reset period. the set-down waveform is applied to the scan electrode and the sustain bias waveform having a voltage not smaller than 80V but not greater than 120V is applied to the sustain electrode, and during the address period, a scan pulse (SP) which falls from the scan reference voltage (Vsc) is applied to the scan electrode (Y) and the sustain bias waveform, which has been applied during the set-down period, is continuously applied to the sustain electrode (Z), thereby restraining generation of the surface discharge between the scan electrode (Y) and the sustain electrode (Z) during the address period.

In this case, although the scan reference waveform (−Vsc) has the minus level, a sufficient voltage difference can be obtained between the scan pulse (SP) which falls to the voltage (−Vy) from the scan reference voltage (−Vsc) and the data pulse applied to the address electrode (X), and thus an electrical burden of the driving circuit can be reduced.

During the sustain period, a plurality of sustain pulses (sus) are alternately applied to the scan electrode (Y) and the sustain electrode (Z). Of the sustain pulses applied during the sustain period, sustain pulses which are first applied to the scan electrode and the sustain electrode, respectively, do not overlap with each other, and sustain pulses which are finally applied to the scan electrode and the sustain electrode, respectively, also do not overlap with each other. The reason for this is to enhance the luminance efficiency and stabilize the sustain discharge by applying the greater number of sustain pulses to the scan electrode (Y) and to the sustain electrode (Y) during the limited sustain period.

When the first sustain pulse is applied during the sustain period, the surface discharge between the scan electrode (Y) and the sustain electrode (Z) may become unstable due to an interference of the address electrode (X). Thus, in order to avoid such a problem, a certain voltage is applied to the address electrode (X) when the first sustain pulse is applied to one of the scan electrode (Y) and the sustain electrode (Z), to thereby stabilize the sustain discharge.

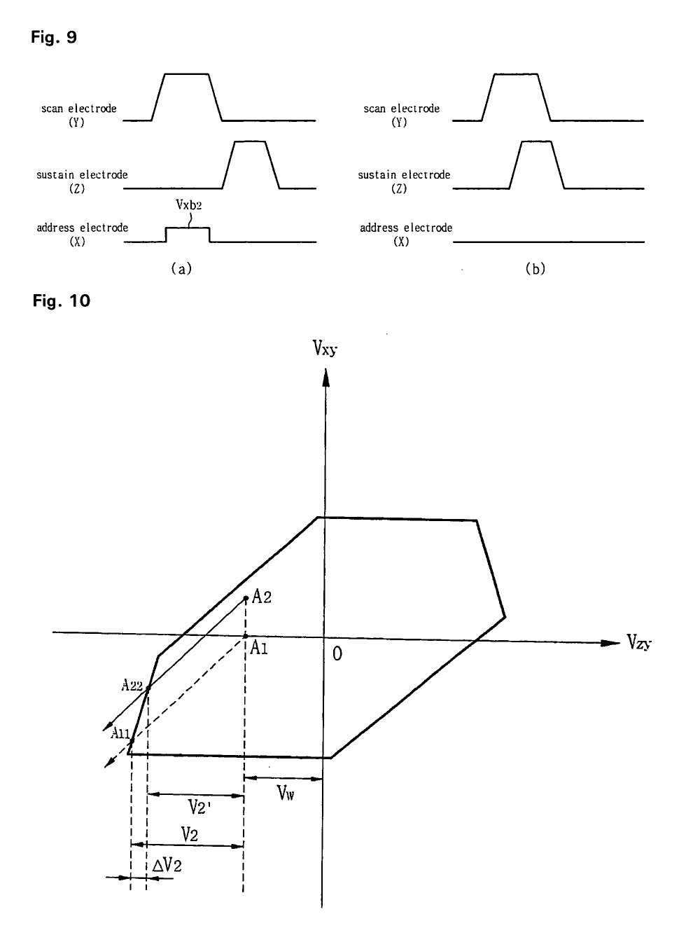

FIG. 9 is a view for explaining a second positive polarity pulse applied to the address electrode (X) during the sustain period when the plasma display apparatus is driven in accordance with the first embodiment of the present invention.

With reference to FIG. 9, (a) shows that, of driving waveforms according to the method for driving the plasma display apparatus in accordance with the present invention, when the first sustain pulse is applied to one of the scan electrode (Y) and the sustain electrode (Z) during the sustain period, a second positive polarity pulse of a positive polarity voltage (Vxb2) is applied to the address electrode (X), and (b) shows a state of the address electrode in the other remaining sustain pulses than the first sustain pulse during the sustain period among the driving waveforms according to the method for driving the plasma display apparatus in accordance with the present invention.

With reference to FIG. 9(a), in a state that the first sustain pulse is applied to one of the scan electrode (Y) and the sustain electrode (Z), when the second positive polarity pulse is applied to the address electrode (X), a voltage difference between the electrode, which can be the scan electrode (Y) or the sustain electrode (Z), to which the first sustain pulse is being applied, and the address electrode (X) is reduced so that the surface discharge between the scan electrode (Y) and the sustain electrode (Z) can be strengthened while the facing discharge between the scan electrode (Y) and the address electrode (X) can be weakened, thereby stabilizing the sustain discharge.

With reference to FIG. 9(b), as the sustain discharge is stabilized by the first sustain pulse, the following sustain discharge occurs depending on a distribution of wall charges within the discharge cells formed by the first sustain pulse, and accordingly, when the sustain pulse is supplied thereafter, the sustain discharge can occur in a stable manner even without the second positive polarity pulse (so, the second positive polarity pulse is omitted).

The voltage (Vxb2) of the second positive polarity pulse can be the same as the voltage (Vxb1) of the first positive polarity pulse during the set-up period of the reset period as described above, or can be the same as the voltage (Vd) of the data pulse applied to the address electrode (X) of the address period.

As stated above, the plasma display apparatus and its driving method in accordance with the present invention can be more effectively applied for the long gap structure in which the distance between the scan electrode (Y) and the sustain electrode (Z) is longer than that between the scan electrode (Y) and the address electrode (X). The reason for this is because there is a high possibility that the surface discharge between the scan electrode (Y) and the sustain electrode (Z) becomes unstable due to the interference by the voltage of address electrode (X), so under the condition, the present invention is quite effective.

The long gap is defined as the distance between the scan electrode (Y) and the sustain electrode (Z), which is preferably not smaller than 90 um (micrometer) but not greater than 200 um (micrometer).

The scan electrode (Y) and the sustain electrode (Z) can comprise a transparent electrode and a bus electrode, respectively, or can be formed only with the transparent electrode. In this case, the distance between the scan electrode (Y) and the sustain electrode (Z) refers to a shorter one of a distance between the transparent electrodes of the scan electrode (Y) and the sustain electrode (Z) and a distance between the bus electrodes of the scan electrode (Y) and the sustain electrode (Z).

FIG. 10 is a view showing a voltage curve (Vt-Curve) for explaining a process of a change in a voltage within a discharge cell during the set-up period when the plasma display apparatus is driven in accordance with the first embodiment of the present invention.

With reference to FIG. 10, a point A1 indicates a state of a wall voltage within a discharge cell right after the last sustain pulse is applied to the sustain electrode (Z).

Thereafter, during the set-up period, a set-up waveform which rises up to the first voltage (Vsc) at the first slope starting from a ground level (GND) and then rises up to the second voltage (Vcs+Vs) at the second slope is applied to the scan electrode (Y), and at this time, when the first positive polarity pulse of the positive voltage (Vxb1) is applied to the address electrode (X), the voltage is shifted to a point A2 within the discharge cell. That is, as the voltage of the first positive polarity pulse applied to the address electrode (X) is added to the wall voltage at the point A1, the voltage is shifted to the point A2.

When the set-up waveform which rises up to the first voltage (Vsc) at the first slope starting from the ground level (GND) and then rises up to the second voltage (Vsc+Vs) at the second slope is applied to the scan electrode (Y), a cell voltage is moved in the direction of a solid line arrow.

At the moment when the sum of the wall voltage (Vw) at the point A2 and the voltage (Vsc+Vs) of the set-up waveform applied from outside exceeds a discharge firing voltage (Vw+V₂′), the set-up discharge of the surface discharge type occurs stably between the scan electrode (Y) and the sustain electrode (Z) at a point A22.

If the address electrode (X) is sustained at the ground level (GND) during the set-up period, when the set-up waveform is applied to the scan electrode (Y), the voltage within the discharge cell is moved in the direction of a dotted line arrow.

At the moment when the sum of the wall voltage (Vw) and the voltage (Vsc+Vs) of the set-up waveform applied from outside exceeds the discharge firing voltage (Vw+V₂), the surface discharge occurs stably between the scan electrode (Y) and the sustain electrode (Z) at a point A11.

In this respect, since the point A11 is adjacent to the facing discharge region, there is a high probability that the facing discharge occurs unintentionally between the scan electrode (Y) and the address electrode (X) at the point. Considering that, generally, the facing discharge has the characteristics of a strong discharge with a large amount of illumination, the occurrence of the unintentional facing discharge works as a negative critical factor to degrade the brightness of the plasma display apparatus.

Therefore, in the plasma display apparatus and its driving method in accordance with the first embodiment of the present invention, as described above, the occurrence of the undesired facing discharge between the scan electrode (Y) and the address electrode (X) during the set-up period can be prevented by applying the first positive polarity pulse, namely, the positive voltage (Vx), to the address electrode (X) before or at the time point when the set-up waveform is applied.

That is, by moving the point where the surface discharge occurs between the scan electrode (Y) and the sustain electrode (Z) from A11 to A22, the unintentional facing discharge can be prevented from occurring between the scan electrode (Y) and the address electrode (Z). In addition, as shown in FIG. 10, by moving the point where the surface discharge occurs between the scan electrode (Y) and the sustain electrode (Z) from A11 to A22, the size of the set-up voltage applied to the scan electrode (Y) to generate the set-up discharge can be reduced.

This can be expressed by equation (2) shown below.
ΔV₂=V₂−V₂′ [Equation 2]

The voltage V₂ is a minimum voltage value of the set-up waveform required for the scan electrode (Y) for the set-up discharge at the point A11, and V₂′ is a minimum voltage value of the set-up waveform required for the scan electrode (Y) for the set-up discharge at the point A22.

With reference to Equation (2) and FIG. 10, according to the driving method in accordance with the present invention, by moving the point at which the surface discharge occurs between the scan electrode (Y) and the sustain electrode (Z) from A11 to A22 by applying the first positive polarity pulse to the address electrode (X) before the set-up waveform is applied or in synchronization with the set-up waveform, the minimum voltage value of the set-up waveform required for the scan electrode (Y) to generate the set-up discharge can be lowered by a voltage ΔV₂.

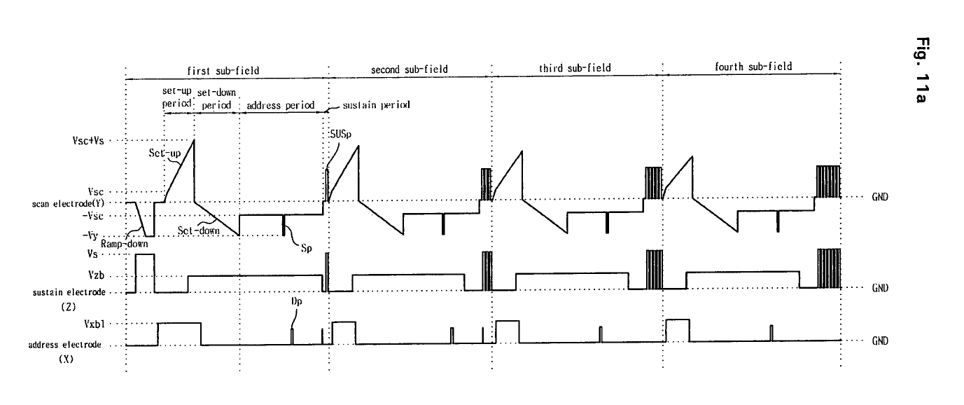

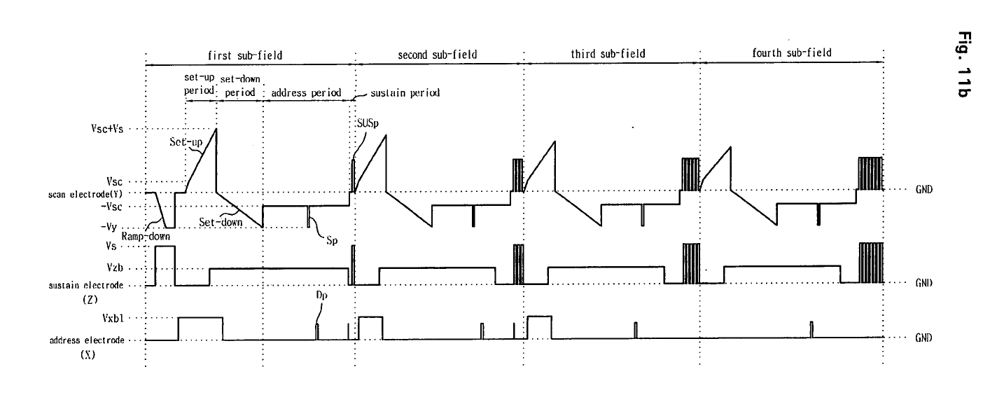

FIGS. 11a and 11b are views showing driving waveforms at a plurality of sub-field sections when the plasma display apparatus is driven in accordance with the first embodiment of the present invention.

First, with reference to FIG. 11a, the set-up waveform which gradually rises up to the first voltage at the first slope and then also gradually rises up to the second voltage at the second slope to the scan electrode (Y) during the set-up period of the reset period at every sub-field of a frame, and the first positive polarity pulse is applied to the address electrode (X) while the set-up waveform is being applied to the scan electrode (Y).

While the set-up waveform is being applied to the scan electrode (Y) during the set-up period of the reset period of the first sub-field with the lowest gray level weight value among the plurality of the sub-fields, the first positive polarity pulse applied to the address electrode (X) has a larger pulse width than that applied to the address electrode (X) at a different sub-field.

The reason for this is to further stabilize the surface discharge between the scan electrode (Y) and the sustain electrode (Z) at the first sub-field because the number of the sustain pulses applied during the sustain period is the smallest at the first sub-field with the lowest gray level weight value, having a high possibility that the discharge is unstable.

With reference to FIG. 11b, unlike in the case of FIG. 11a, the first positive polarity pulse is applied at the certain number of sub-fields selected from the plurality of sub-fields included in the frame. Namely, the first positive polarity pulse is applied at some low gray level sub-fields with a relatively low gray level value among the plurality of the sub-fields of the frame.

Herein, the low gray level sub-fields are sub-fields from the first to the second or to the third sub-field in the sequential order beginning from the sub-field with the lowest gray level weight value. For example, in case where one frame comprises total 12 sub-fields from the first one to the twelfth one in the sequential order of the size of the gray level weight value, the first sub-field with the lowest gray level weight value, the second sub-field with the second-lowest gray level weight value, and the third sub-field with the third-lowest gray level weight value are set as the low gray level sub-fields. Also, in this case, while the set-up waveform is being applied to the scan electrode (Y) during the set-up period of the reset period of the first sub-field with the lowest gray level weight value, the first positive polarity pulse applied to the address electrode (X) has a larger width than that applied to the address electrode at a different sub-field.

The reason for applying the first positive polarity pulse only at the low gray level sub-fields among the sub-fields of the frame is because a sufficiently stable resetting can be performed at the other remaining sub-fields except for the low gray level sub-fields by using the wall charges within the discharge cell formed in the preceding sub-field, so the first positive polarity pulse can be omitted at the other remaining sub-fields.

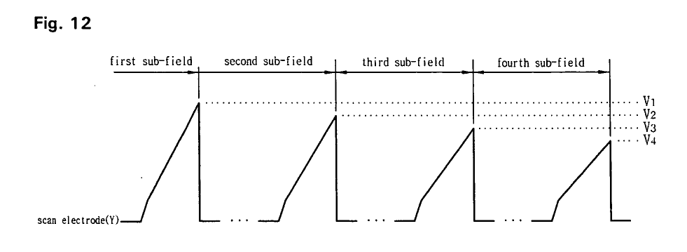

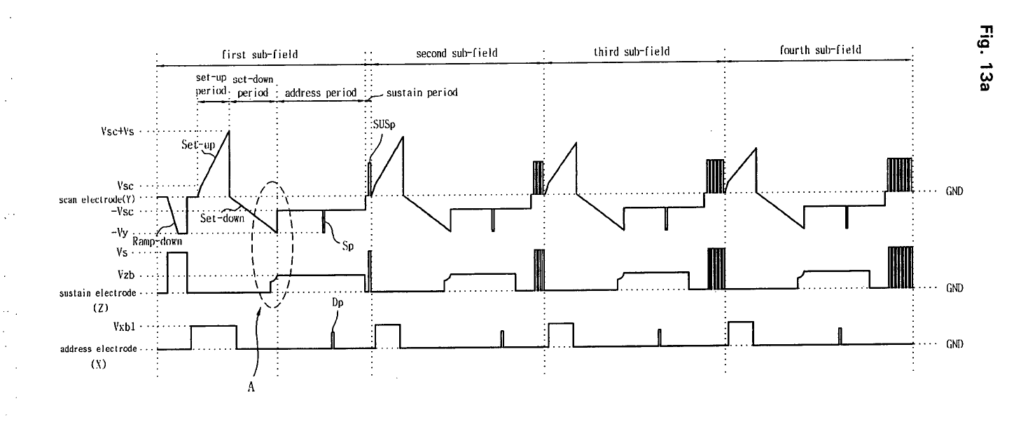

As shown in FIG. 12, each size of voltages of the set-up waveform applied to the scan electrode (Y) during the reset period of one sub-field among the plurality of sub-fields constituting the frame can be set to be different from that of the set-up waveform applied to the scan electrode during the reset period of a different sub-field. Namely, among the sub-fields of the frame, when the size of the voltage of the set-up waveform at the first sub-field is V1, the size of the voltage of the set-up waveform at the second sub-field is V2, the size of the voltage of the set-up waveform at the third sub-field is V3, and the size of the voltage of the set-up waveform at the fourth sub-field is V4, each size of the voltages can be set to be different.

In this case, among the plurality of sub-fields, the size of the voltage of the set-up waveform at the sub-fields with the relatively low gray level weight value is greater than the size of the voltage of the set-up waveform of the other different sub-fields with a relatively high gray level weight value, because there is a relatively high possibility that the discharge can be unstable at the sub-fields with the relatively low gray level weight value.

In the first embodiment of the present invention, the sustain bias waveform is applied to the sustain electrode (Z) starting from the set-down period that follows the set-up period of the reset period, but in this respect, for a stable discharge and quick addressing, the sustain bias waveform may not be applied during the set-down period, which will now be described in a second embodiment of the present invention.

### Second Embodiment

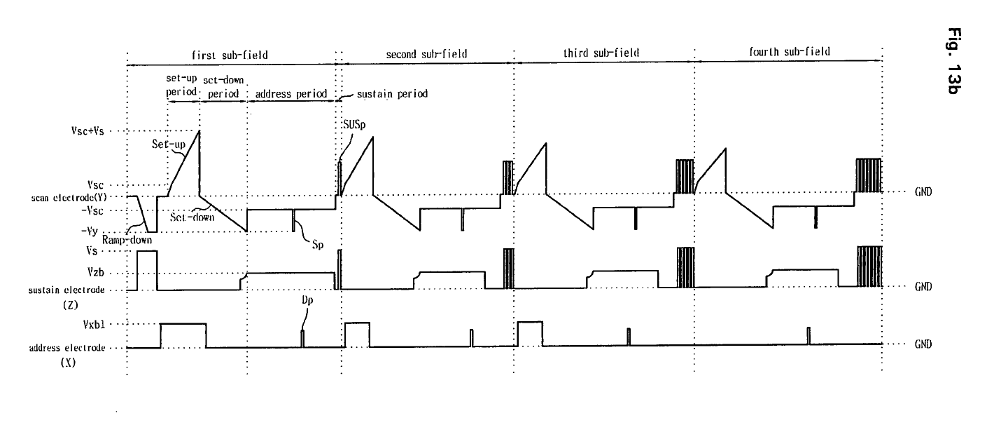

FIGS. 13a and 13b are views for explaining a method for driving a plasma display apparatus in accordance with a second embodiment of the present invention.

The same repeated descriptions for the method for driving the plasma display apparatus in accordance with the second embodiment of the present invention as in the first embodiment of the present invention will be omitted.

As shown, in the plasma display apparatus in accordance with the second embodiment of the present invention, a set-up waveform which gradually rises up to a first voltage at a first slope and then gradually rises up to a second voltage at a second slope is applied to the scan electrode (Y) during the set-up period of the reset period at one or more sub-fields among a plurality of sub-fields of a frame, a first positive polarity pulse is applied to the address electrode (X) while the set-up waveform is being applied to the scan electrode (Y), and a sustain bias waveform (Vzb) with a rising slope is applied to the sustain electrode during a rear portion of the reset period, namely, before the address period starts, and the waveform is subsequently sustained until the address period. At this time, the rising slope starts from a voltage higher than the ground level.

First, with reference to FIG. 13a, the first positive polarity pulse is applied at each of the plurality of the sub-fields of the frame, and likewise as in the method for driving the plasma display apparatus in accordance with the first embodiment of the present invention, while the set-up waveform is being applied to the scan electrode (Y) during the set-up period of the reset period of the first sub-field with the lowest gray level weight value, the first positive polarity pulse applied to the address electrode (X) has a larger width than that of the first positive polarity pulse applied to the address electrode at the other remaining sub-fields.

Next, with reference to FIG. 13b, unlike in the case of FIG. 13a, the first positive polarity pulse is applied only the certain number of sub-fields selected from the plurality of sub-fields included in the frame. Namely, the first positive polarity pulse is applied to the address electrode at some low gray level sub-fields with a relatively low gray level value among the plurality of the sub-fields of the frame. In this case, the low gray level sub-fields are sub-fields from the first to the third sub-field in the sequential order beginning from the sub-field with the lowest gray level weight value.

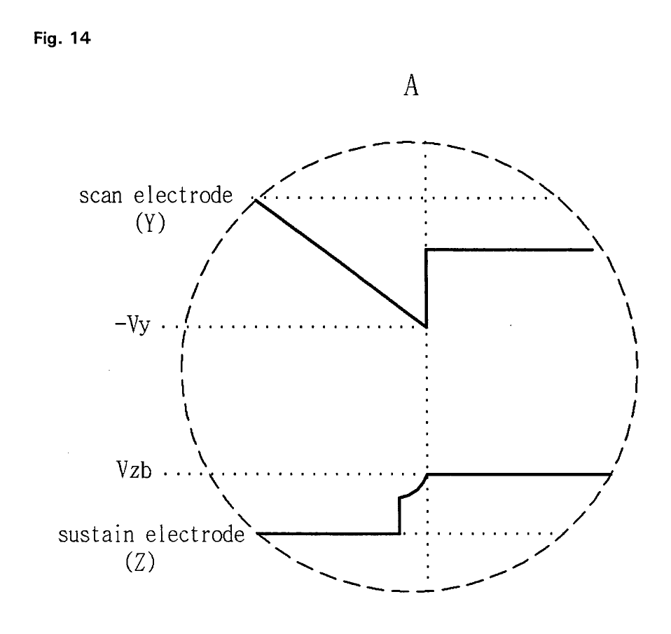

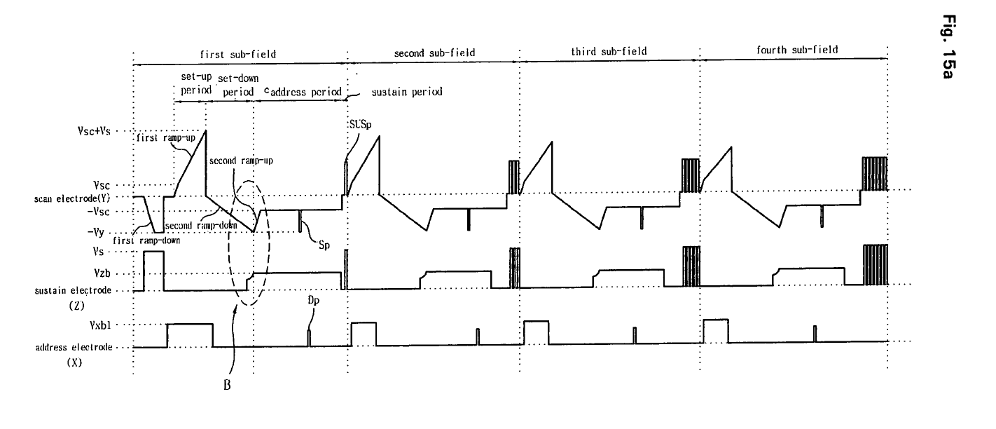

A detailed driving waveform applied to the sustain electrode (Z) during the rear portion of the reset period will now be described with reference to FIG. 14.

FIG. 14 is a view showing a waveform applied to the sustain electrode (Z) during the rear portion of the reset period when the plasma display apparatus is driven in accordance with the second embodiment of the present invention.

FIG. 14 is an enlarged view of a portion ‘A’ of FIG. 13a. Before the address period starts, the sustain bias waveform (Vzb) with the rising slope is applied to the sustain electrode and then sustained during the address period. In other words, the sustain electrode sustains the ground level during the most part of the reset period, and the corresponding voltage is steeply increased from the ground level and then gradually increased at a certain slope during the rear portion of the reset period before the address period, and then the voltage is sustained at the certain bias voltage (Vzb).

As the sustain electrode (Z) sustains the voltage of the ground level (GND) during the most part of the reset period, the set-down discharge occurring at the rear portion of the reset period can be stabilized and the address discharge during the address period can be also stabilized to facilitate a high speed addressing.

In the first and second embodiments of the present invention as described above, the scan reference waveform which steeply rises is applied to the scan electrode (Y) during the address period following the reset period, and in this respect, a scan reference waveform whose voltage is gradually increased, namely, a ramp-up waveform with a slope, can be also applied to the scan electrode (Y) for the stabilization of the discharge. This will now be described in detail in a third embodiment of the present invention.

### Third Embodiment

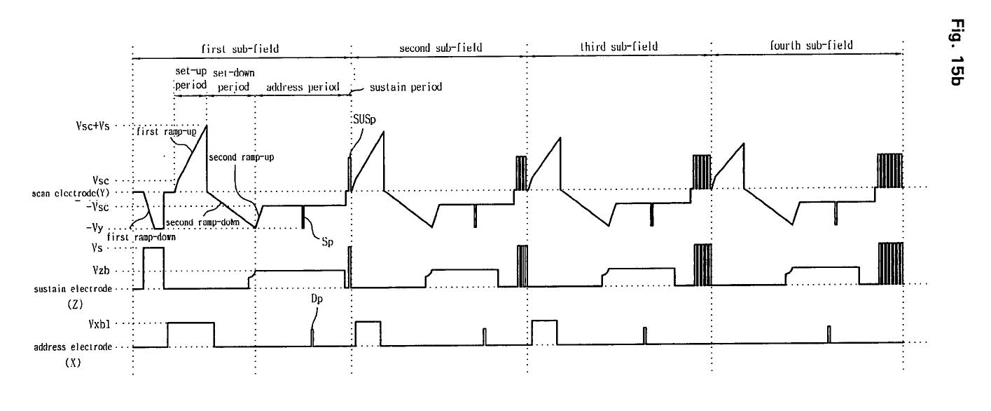

FIGS. 15a and 15b are views for explaining a method for driving a plasma display apparatus in accordance with a third embodiment of the present invention.

The same repeated descriptions for the method for driving the plasma display apparatus in accordance with the third embodiment of the present invention as in the first and second embodiments of the present invention will be omitted.

As shown, in the plasma display apparatus in accordance with the third embodiment of the present invention, a first ramp-up waveform (first ramp-up waveform) which gradually rises up to a first voltage at a first slope and then gradually rises up to a second voltage at a second slope is applied to the scan electrode (Y) during the set-up period of the reset period at one or more sub-fields among a plurality of sub-fields of a frame, and the first positive polarity pulse is applied to the address electrode (X) while the first ramp-up waveform is being applied to the scan electrode (Y).

A ramp-down waveform (second ramp-down waveform) which falls down to a third voltage is applied to the scan electrode (Y) during the set-down period following the set-up period, a second ramp-up waveform (second ramp-up waveform) which rises at a certain slope from the third voltage to a fourth voltage is applied to the scan electrode (Y), and then, a scan pulse which falls down to a fifth voltage from the fourth voltage is applied.

As shown, a sustain bias waveform with a rising slope can be applied to the sustain electrode during the rear portion of the reset period and the address period following the reset period, and a sustain bias waveform which does not have a gradually rising slope can be applied to the sustain electrode.

First, with reference to FIG. 15a, the first positive polarity pulse is applied at every sub-field of the frame, and likewise as in the second embodiment of the present invention, while the set-up waveform is being applied to the scan electrode (Y) during the set-up period of the reset period of the first sub-field with the lowest gray level weight value, the first positive polarity pulse applied to the address electrode (X) has a larger pulse width than the first positive polarity pulse applied to the address electrode at the other remaining sub-fields.

Next, with reference to FIG. 15b, unlike in the case of FIG. 15a, the first positive polarity pulse is applied only the certain number of sub-fields selected from the plurality of sub-fields included in the frame. Namely, the first positive polarity pulse is applied to the address electrode at some low gray level sub-fields with a relatively low gray level value among the plurality of the sub-fields of the frame. In this case, the low gray level sub-fields are sub-fields from the first to the third sub-field in the sequential order beginning from the sub-field with the lowest gray level weight value.

A detailed driving waveform applied to the scan electrode (Y) at a point where the address period starts will now be described with reference to FIG. 14.

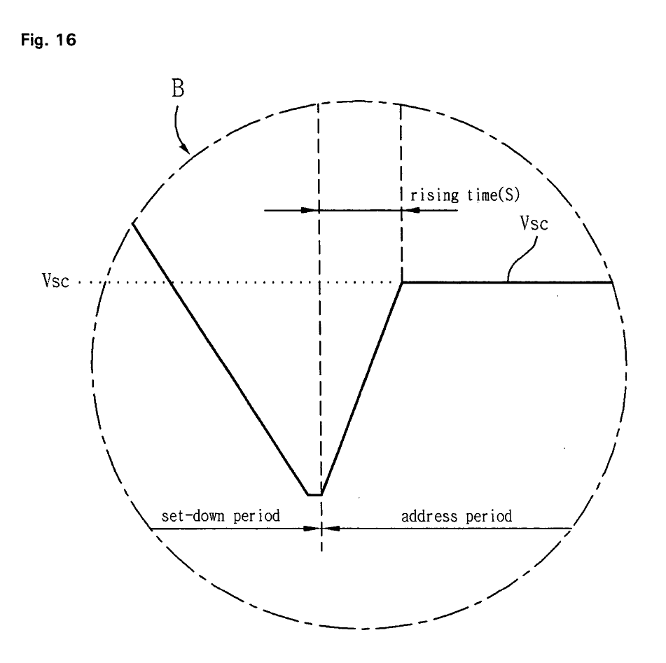

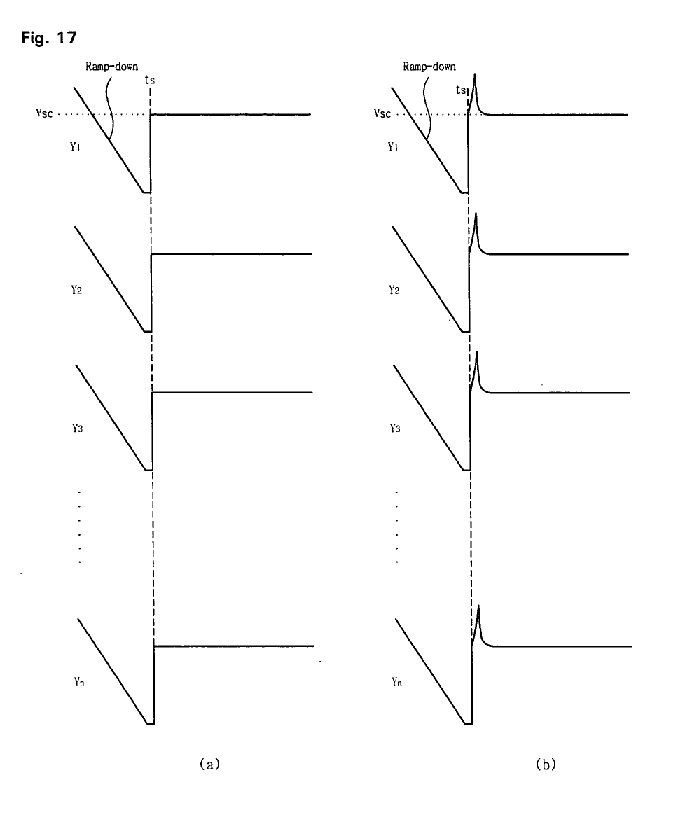

FIG. 16 is a view showing a waveform applied to the scan electrode (Y) during the rear portion of the reset period when the plasma display apparatus is driven in accordance with the third embodiment of the present invention.

FIG. 16 is an enlarged view of a portion ‘B’ of FIG. 15a. A ramp-down waveform which falls down to the third voltage is applied to the scan electrode (Y) during the set-down period of the reset period, and a first ramp-up waveform which rises at a certain slope from the third voltage up to the fourth voltage is applied.

When the scan reference waveform which gradually rises from the point where the address period starts is applied to the scan electrode (Y), a noise generated in the driving waveforms can be reduced.

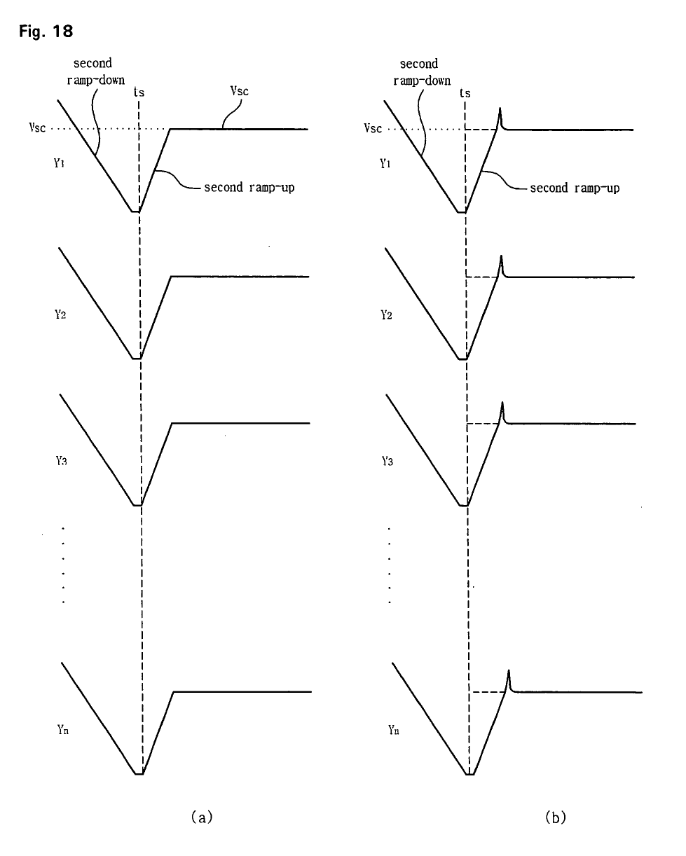

FIGS. 17 and 18 are views for explaining noise according to a scan reference waveform with respect to driving waveforms of a related art and those of the present invention.

FIG. 17 shows a noise state according to the scan reference waveform of driving waveforms in accordance with the related art, and FIG. 18 shows a noise state according to the present invention.

With reference FIG. 17, as shown in (a), a time point at which the scan reference waveform applied to the scan electrode (Y) during the address period is the same (ts) at every scan electrode (Y), and the voltage is steeply increased and applied. Accordingly, as shown in (b) of FIG. 17, noise is generated from the driving waveform applied to the scan electrode. Noise is generated due to coupling through capacitance of a panel, and at a time point when the voltage of the scan reference waveform is increased steeply, a rising noise is generated from a driving waveform applied to the scan electrode (Y). The noise electrically damages a driving element of the plasma display panel, for example, a scan driver IC (Integrated Circuit) for applying scan pulses to the scan electrode (Y).

With reference to FIG. 18, as shown in (a), the scan reference waveform applied to the scan electrode (Y) during the address period includes a second ramp-up waveform whose slope is gradually increased and reaches the scan reference voltage (Vsc).

The slope of the second ramp-up waveform is smaller than a sustain pulse applied during the sustain period. In detail, the second ramp-up waveform has the smaller slope than ER-up time of the sustain pulse. The second ramp-up waveform is sustained at a fourth voltage, namely, the scan reference voltage (Vsc).

The second ramp-up waveform is applied until before a first one of scan pulses applied to the scan electrode (Y) is applied. Time for applying the second ramp-up waveform is within a range of greater than 0 μs (micro seconds) but not greater than 20 μs, and preferably, within a range of greater than 6 μs but not greater than 10 μs.

Accordingly, the size of the noise generated by the scan reference waveform applied to the scan electrode during the address period is reduced.

Meanwhile, in the above driving method, time for increasing the voltage of the scan reference waveform, namely, the second ramp-up waveform, applied to every scan electrode (Y) is controlled to be the same within the range of greater than 0 μs but not greater than 20 μs, and preferably, within the range of greater than 6 μs but not greater than 10 μs, and in this case, differently, the scan electrodes (Y) can be divided into a plurality of scan electrode groups and time for applying the second ramp-up waveform can differ according to each scan electrode group.

Meanwhile, in the second and third embodiments of the present invention, the voltage value of the sustain bias waveform applied before the initial scan pulse is steeply increased in one section and the voltage value is gradually increased in another section. In this respect, however, only a section in which the voltage value is steeply increased can be formed or only a section in which the voltage value is gradually increased can be formed. In addition, it has been described that the time point at which the sustain bias waveform is applied and the time point at which the scan reference waveform is applied are different, but the time point at which the two waveforms are applied can be substantially the same.

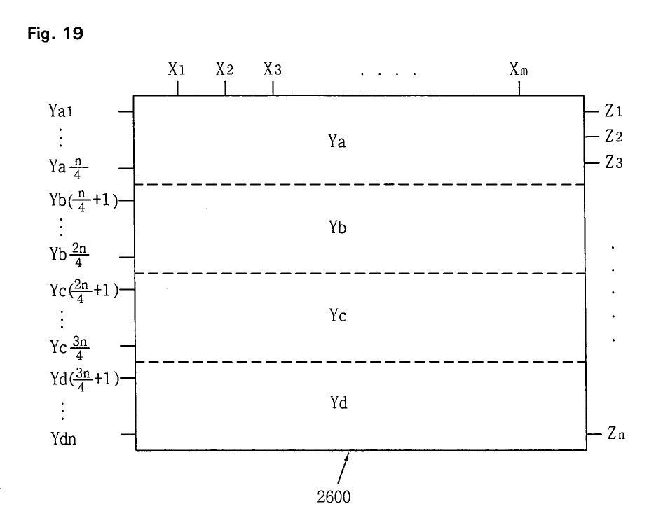

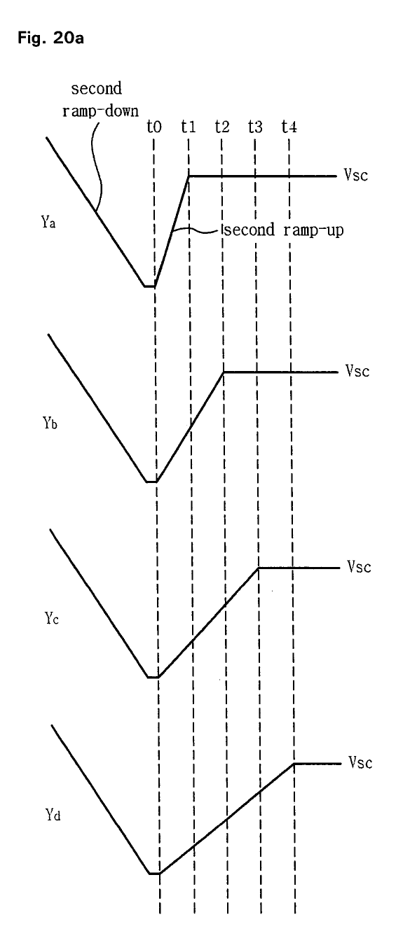

FIG. 19 is a view for explaining scan electrode groups of the plasma display panel (PDP) in accordance with the present invention.

With reference to FIG. 19, the scan electrodes (Y) of the PDP 2600 are divided into, for example, a Ya electrode group (Ya₁˜Ya(n)/4), a Yb electrode group (Yb((n/4)+1)˜Yb(2n)/4), a Yc electrode group (Yc((2n/4)+1)˜Yc(3n)/4) and a Yd electrode group (Yd((3n/4)+1)˜Yd(n)).

The number of scan electrodes included in each scan electrode group (Ya˜Yd electrode groups) is set to be the same, but it can be also possible to set the number of scan electrodes included in each electrode group (Ya˜Yd electrode groups) differently. For example, the Ya electrode group can comprise 100 scan electrodes while the Yb electrode group can comprise 200 scan electrodes.

The number of the scan electrode groups can be also controlled. In addition, on the assumption that the number of scan electrode groups is within a range of a minimum 2 but smaller than the total number of maximum scan electrodes, namely, when the total number of scan electrodes is ‘n’, it can be set in the range of 2≦N≦(n-1) (N is the number of scan electrode groups).

In this manner, time for applying the second ramp-up waveform to the scan electrode groups can be controlled within a period until before the first scan pulse is applied to the scan electrode.

When time for applying the second ramp-up waveform, it is preferred to apply the ramp-up waveform with the same application time to every scan electrode (Y) included in each scan electrode group. For example, application time of the second ramp-up waveform applied from the scan electrode Ya₁ to the scan electrode Ya(n)/4 can be set as 5 μs, and application time of the second ramp-up waveform applied from the scan electrode Yb((n/4)+1) to the scan electrode Yb(2n)/4 can be set as 10 μs. In this manner, the application time of the second ramp-up waveform applied to scan electrodes belonging to one scan electrode group are set to be the same.

In addition, a difference between application time of two second ramp-up waveforms each having a different application time can be set to be the same. For example, with reference to FIG. 19, the application time of the second ramp-up waveform applied from the scan electrode Ya₁ to the scan electrode Ya(n)/4 can be set as 5 μs, application time of the second ramp-up waveform applied from the scan electrode Yb((n/4)+1) to the scan electrode Yb(2n)/4 can be set as 10 μs, application time of the second ramp-up waveform applied from the scan electrode Yc((2n/4)+1) to the scan electrode Yc(3n)/4 can be set as 15 μs, and application time of the second ramp-up waveform applied from the scan electrode Yd((3n/4)+1) to the scan electrode Yd(n) can be set as 20 μs.

In other words, a difference between the application time of the second ramp-up waveform applied to the Ya scan electrode group and the application time of the second ramp-up waveform applied to the Yb scan electrode group is 5 μs, a difference between the application time of the second ramp-up waveform applied to the Yb scan electrode group and the application time of the second ramp-up waveform applied to the Yc scan electrode group is also 5 μs, and a difference between the application time of the second ramp-up waveform applied to the Yc scan electrode group and the application time of the second ramp-up waveform applied to the Yd scan electrode group is also 5 μs.

In addition, a difference between an application time of two second ramp-up waveforms each having a different application time can be set to be different. For example, the application time of the second ramp-up waveform applied from the scan electrode Ya₁ to the scan electrode Ya(n)/4 can be set as 5 μs, application time of the second ramp-up waveform applied from the scan electrode Yb((n/4)+1) to the scan electrode Yb(2n)/4 can be set as 7 μs, application time of the second ramp-up waveform applied from the scan electrode Yc((2n/4)+1) to the scan electrode Yc(3n)/4 can be set as 15 μs, and application time of the second ramp-up waveform applied from the scan electrode Yd((3n/4)+1) to the scan electrode Yd(n) can be set as 20 μs.

In other words, a difference between the application time of the second ramp-up waveform applied to the Ya scan electrode group and the application time of the second ramp-up waveform applied to the Yb scan electrode group is 2 μs, a difference between the application time of the second ramp-up waveform applied to the Yb scan electrode group and the application time of the second ramp-up waveform applied to the Yc scan electrode group is 8 μs, and a difference between the application time of the second ramp-up waveform applied to the Yc scan electrode group and the application time of the second ramp-up waveform applied to the Yd scan electrode group is 5 μs.

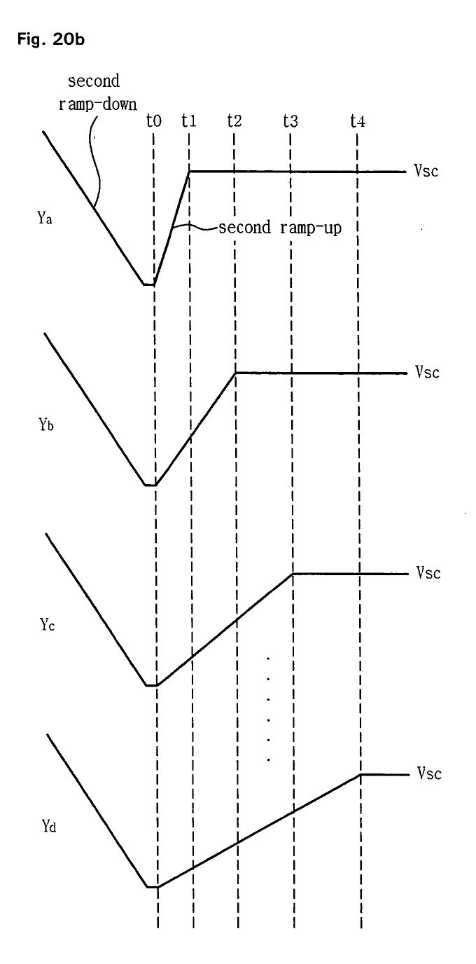

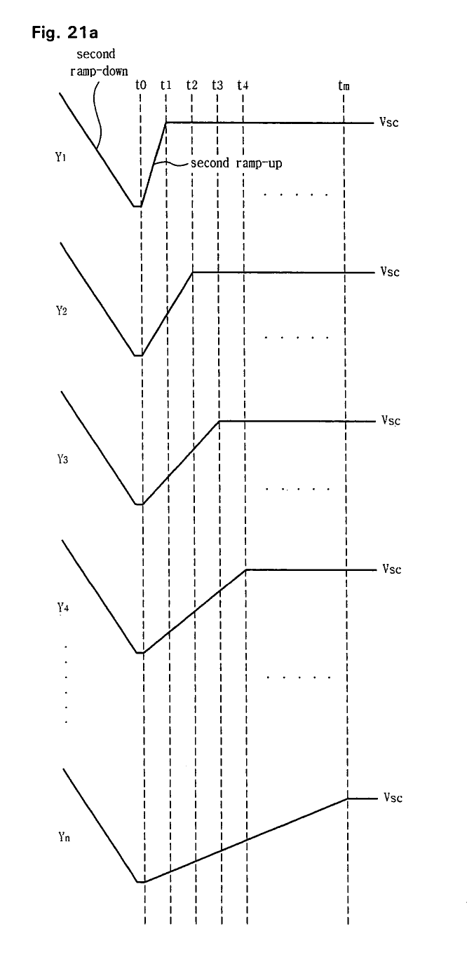

FIGS. 20a and 20b are views for explaining a driving method for controlling time for applying the second ramp-up waveform according to the scan electrode groups in accordance with the present invention.

In the method for driving the plasma display apparatus in accordance with the present invention, scan electrodes are divided into two or more scan electrode groups comprising at least one or more scan electrodes, and an application time of a ramp-up waveform applied to at least one or more scan electrodes is different from an application time of a ramp-up waveform applied to at least one or more different scan electrode groups.

As shown in FIG. 20a, the second ramp-up waveform which starts to rise from a time point t₀ and rises to a time point t₁ is applied to every scan electrode included in the Ya scan electrode group of FIG. 19 during the address period, and the second ramp-up waveform which starts to rise from a time point t₀ and rises to a time point t₂ is applied to every scan electrode included in the Yb scan electrode group during the address period. In addition, the second ramp-up waveform which starts to rise from a time point t₀ and rises to a time point t₃ is applied to every scan electrode included in the Yc scan electrode group during the address period, and the second ramp-up waveform which starts to rise from a time point t₀ and rises to a time point t₄ is applied to every scan electrode included in the Yd scan electrode group during the address period,

Though the second ramp-up waveforms each having the different application time are applied according to each scan electrode group in FIG. 20a, it can be also possible that second ramp-up waveforms each having a different application time is applied only to a certain number of electrode groups among the scan electrode groups.

For example, a second ramp-up waveform which starts to rise at a time point of to and reaches the scan reference voltage (Vsc) at the time point t₁ can be applied to every scan electrode of the Ya scan electrode group during the address period, while a second ramp-up waveform which starts to rise at the time point t₀ and reaches the scan reference voltage (Vsc) at the time point t₂ can be applied to every scan electrode of the Yb, Yc and Yd scan electrode groups during the address period.

In the case where the scan electrodes (Y) are divided into the plurality of electrode groups and the second ramp-up waveform is applied thereto, it is preferred that the number of the scan electrode groups are set to be two or greater but not greater than the total number of the scan electrodes and driven.

Each scan electrode group can comprise one or more scan electrodes, and all of the scan electrode groups can comprise the same number of scan electrodes or the different number of scan electrodes. For example, the Ya scan electrode group can comprise 100 scan electrodes and the Yb scan electrode group can comprise 200 scan electrodes.

Preferably, a second ramp-up waveform with the same application time is applied to every scan electrode included in the same scan electrode group. Namely, application time of the second ramp-up waveform applied to the scan electrodes from Ya1 to Ya(n)/4 can be set to be the same as 10 μs.

A difference between application time of two second ramp-up waveforms each having a different application time can be set to be the same.

Or, the difference between application time of the two second ramp-up waveforms each having the different application time can be set to be different, and driving waveforms in this case will now be described with reference to FIG. 20b.

With reference to FIG. 20b, a difference between application time of two ramp-up waveforms each having a different application time is different. That is, when a difference between an application time of the second ramp-up waveform applied to the Ya scan electrode group and an application time of the second ramp-up waveform applied to the Yb scan electrode group, namely, the difference between t₂ and t₁ is 5 μs, a difference between the application time of the second ramp-up waveform applied to the Yb scan electrode and the application time of the second ramp-up waveform applied to the Yc scan electrode group, namely, the difference between t₃ and t₂ is set to be 7 μs and a difference between the application time of the second ramp-up waveform applied to the Yc scan electrode group and the application time of the second ramp-up waveform applied to the Yd scan electrode group, namely, the difference between t₄ and t₃ is set to be 10 μs.

Accordingly, the size of the noise generated due to the ramp-up waveform applied to the scan electrodes during the address period as shown in FIG. 18 can be reduced.

In the above descriptions with reference to FIGS. 20a and 20b, the scan electrodes (Y) are divided into a plurality of scan electrode groups and the application time of the second ramp-up waveform applied to the scan electrodes during the address period is set to be different according to scan electrodes, and differently, it is also possible to set each application time of the second ramp-up waveform applied to each scan electrode during the address period to be different according to each scan electrode.

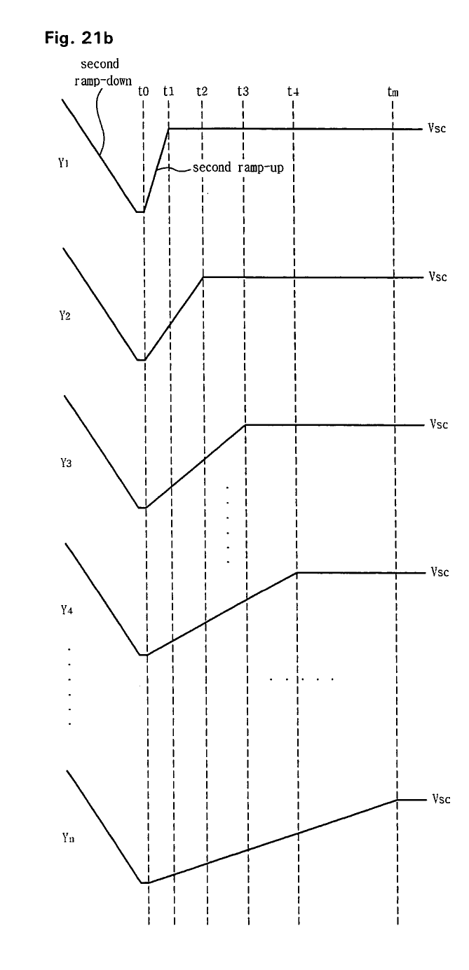

FIGS. 21a and 21b are views for explaining a driving method for differently controlling time for applying the second ramp-up waveform according to the scan electrode groups in accordance with the present invention.

As shown in FIGS. 21a and 21b, in the method for driving the plasma display apparatus in accordance with the present invention, the application time of the second ramp-up waveform applied to the scan electrode (Y) during the address period is controlled to be different according to each scan electrode (Y).

With reference to FIG. 21a, a second ramp-up waveform which starts to rise at the time point t₀ and reaches the scan reference voltage (Vsc) at the time point t₁ is applied to a scan electrode Y₁ during the address period, and a second ramp-up waveform which starts to rise at a time point t₀ and reaches the scan reference voltage (Vsc) at the time point t₂ is applied to a scan electrode Y₂ during the address period. In addition, a second ramp-up waveform which starts to rise at the time point t₀ and reaches the scan reference voltage (Vsc) at the time point t₃ is applied to a scan electrode Y₃ during the address period, and a second ramp-up waveform which starts to rise at the time point t₀ and reaches the scan reference voltage (Vsc) at the time point t₄ is applied to a scan electrode Y₄ during the address period. In other words, the second ramp-up waveform which starts to rise at the time point t₀ and reaches the scan reference voltage (Vsc) at the time point tₘ is applied to the Yₘ scan electrode during the address period.

Though the second ramp-up waveforms each having a different application time are applied according to each scan electrode, it is also possible to select a certain number of electrodes from the scan electrodes and apply the second ramp-up waveforms each having a different application time only to the selected scan electrodes.

For example, the second ramp-up waveform which starts to rise at the time point t₀ and reaches the scan reference voltage (Vsc) at the time point t₁ is applied to the scan electrode Y₁ during the address period, while the second ramp-up waveform which starts to rise at the time point to and reaches the scan reference voltage (Vsc) at the time point t₂ can be applied to the scan electrodes Y₂, Y₃, Y₄ and Yₘ during the address period.

In addition, the difference between application time of two second ramp-up waveforms each having a different application time is the same. That is, when a difference between an application time of the ramp-up waveform applied to the scan electrode Y₁ and an application of the ramp-up waveform applied to the scan electrode Y₂ is 5 μs, a difference between the application time of the second ramp-up waveform applied to the scan electrode Y₂ and the application time of the second ramp-up waveform applied to the scan electrode Y₃ and a difference between the application time of the second ramp-up waveform applied to the scan electrode Y₃ and the application time of the second ramp-up waveform applied to the scan electrode Y₄ can be set to be the same as 5 μs.

Differently, the difference between application time of two second ramp-up waveforms each having a different application time can be set to be different, and driving waveforms in this case will now be described with reference to FIG. 21b.

With reference to FIG. 21b, a difference between each application time of two second ramp-up waveforms is different. That is, when a difference between the application time of the second ramp-up waveform applied to the scan electrode Y₁ and the application time of the second ramp-up waveform applied to the scan electrode Y₂ is 5 μs, a difference between the application time of the second ramp-up waveform applied to the scan electrode Y₂ and the application time of the second ramp-up waveform applied to the scan electrode Y₃ can be set as 7 μs and a difference between the application time of the second ramp-up waveform applied to the scan electrode Y₃ and the application time of the second ramp-up waveform applied to the scan electrode Y₄ can be set as 10 μs

Accordingly, the size of the noise generated by the second ramp-up waveform applied to the scan electrodes during the address period can be reduced.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus in which one frame is divided into a plurality of sub-fields to display an image, comprising:
a plasma display panel comprising a scan electrode, a sustain electrode and an address electrode;
a scan driver for applying a set-up waveform which rises up to a first voltage at a first slope and then rises up to a second voltage at a second slope to the scan electrode during a reset period; and
an address driver for applying a first positive polarity pulse to the address electrode while the set-up waveform is being applied to the scan electrode.

2. The apparatus of claim 1, wherein a peak voltage of the first positive polarity pulse is between 1 to 1.5 times the voltage of a data pulse applied to the address electrode during an address period.

3. The apparatus of claim 1, wherein the first positive polarity pulse is applied substantially in synchronization with the set-up waveform.

4. The apparatus of claim 1, wherein the first positive polarity pulse is applied to the address electrode at one or more of the plurality of sub-fields.

5. The apparatus of claim 4, wherein the first positive polarity pulse has the largest pulse width at a sub-field with the lowest gray level weight value among the plurality of sub-fields.

6. The apparatus of claim 1, wherein the first positive polarity pulse is applied at at least one of first and second sub-fields or at at least one of first to third sub-fields in the sequential order beginning from the sub-field with the lowest gray level weight value.

7. The apparatus of claim 1, wherein the first slope is greater than the second slope.

8. The apparatus of claim 1, wherein the size of the first voltage is the substantially same as that of a voltage of a scan reference waveform applied to the scan electrode during the address period that follows the reset period.

9. The apparatus of claim 1, wherein the size of the second voltage applied to the scan electrode at one of the plurality of sub-fields is different from that of the second voltage applied to the scan electrode at the other remaining sub-fields.

10. The apparatus of claim 1, wherein a sustain bias waveform having a voltage size between 80V and 120V is applied to the sustain electrode during the address period.

11. The apparatus of claim 1, wherein first sustain pulses respectively applied to the scan electrode and the sustain electrode do not overlap with each other, and last sustain pulses respectively applied to the scan electrode and the sustain electrode do not overlap with each other.

12. The apparatus of claim 1, wherein while the first sustain pulse is being applied to the scan electrode or to the sustain electrode, a second positive polarity pulse is applied to the address electrode.

13. The apparatus of claim 12, wherein a voltage of the second positive polarity pulse is the substantially same as that of the first positive polarity pulse or that of the data pulse applied to the address electrode.

14. The apparatus of claim 1, wherein the distance between the scan electrode and the sustain electrode is not smaller than 90 μm but not greater than 200 μm.

15. A plasma display apparatus in which one frame is divided into a plurality of sub-fields to display an image, comprising:
a plasma display panel comprising a scan electrode, a sustain electrode and an address electrode;
a scan driver for applying a set-up waveform which rises up to a first voltage at a first slope and then rises up to a second voltage at a second voltage to the scan electrode during a reset period;
a sustain driver for applying a sustain bias waveform with a rising slope to the sustain electrode during a rear portion of the reset period and an address period that follows the reset period; and
an address driver for applying a first positive polarity pulse to the address electrode while the set-up waveform is being applied to the scan electrode.

16. The apparatus of claim 15, wherein the rising slope starts from a voltage higher than a ground level.

17. A plasma display apparatus in which one frame is divided into a plurality of sub-fields to display an image, comprising:
a plasma display panel comprising a scan electrode, a sustain electrode and an address electrode;
a scan driver for applying to the scan electrode a first ramp-up waveform which rises up to a first voltage at a first slope and then rises up to a second voltage at a second slope during a set-up period, a ramp-down waveform which falls down to a third voltage during a set-down period, applying a second ramp-up waveform which rises up to a fourth voltage from the third voltage during an address period, and then applying a scan pulse which falls down to a fifth voltage from the fourth voltage; and
an address driver for applying a first positive polarity pulse to the address electrode while the set-up waveform is being applied to the scan electrode.

18. The apparatus of claim 17, wherein a slope of the second ramp-up waveform is smaller than that of a sustain pulse applied during a sustain period.

19. The apparatus of claim 17, wherein the second ramp-up waveform is sustained at the fourth voltage during a certain period.

20. The apparatus of claim 17, wherein the ramp-up waveform is applied until before a first one of scan pulses applied to the scan electrode is applied.
